(19) United States
(12) Patent Application Publication
(10) Pub. No.: US 2005/0068602 A1
(43) Pub. Date: Mar. 31, 2005

(54) Optical add-filtering switching device

(76) Inventors: Maurizio Tormen, Milano (IT); Matteo Cherchi, Milano (IT); Hermann A. Haus, Lexington, MA (US); Eleanor L. Haus, Lexington, MA (US)

Correspondence Address: Samuels, Gauthier & Stevens LLP, Suite 3300, 225 Franklin Street, Boston, MA, 02110, US

(21) Appl. No.: 10/663,132

(22) Filed: Sep. 16, 2003

(51) Int. Cl. G02F 1/03; G02F 1/07

(52) U.S. Cl. 359/246

(57) ABSTRACT

An add-filter device includes a plurality of ring resonators that are arranged to receive an optical signal of a specific wavelength and channel to be added onto a bus line that is arranged to receive a plurality of signals. At least one Mach-Zehnder Interferometer (MZI) structures embedded in the plurality of ring resonators. The at least one MZI structure and ring resonators provide the necessary modulation and filtering so that the optical signal can be added to the bus line without affecting the channels contained in the bus line.

### BACKGROUND OF THE INVENTION

The invention relates to the field of optical communication, and in particular to a device that can operate at the same time as a switching device and as an add-filter.

Like every digital communication system, optical communication is based on transmission and reception of ones and zeros. In order to send a signal through a bus line, a source is used to generate a continuous wave (CW) signal and an optical modulator is used to switch on and off the signal from the source, providing in this way the digital encoding of the signal.

In wavelength division multiplexing (WDM) systems, more than one signal can be sent on the same bus line. Each signal can have a different optical carrier that means a different central wavelength. In order to have multiple signals on the same bus, a device is needed, such as an add-filter, which can insert a modulated signal into the bus line without affecting the other channels. However, this arrangement is not efficient because of the large amount of space needed to integrate both the add-filter and modulator.

### SUMMARY OF THE INVENTION

One possible solution to solving the problem in the prior art is to integrate the functionality of both a modulator and an add-filter into a single device.

According to one aspect of the invention, there is provided an add-filter device. The add-filter device includes a plurality of ring resonators that are arranged to receive an optical signal of a specific wavelength to be added onto a bus line that is apt to transmit a plurality of signals at different wavelengths. At least one Mach-Zehnder Interferometer (MZI) structure is embedded in the plurality of ring resonators. The at least one MZI structure and ring resonators provide modulation and filtering so that the optical signal can be added to the bus line without affecting the channels contained in the bus line.

According to another aspect of the invention, there is provided a method of performing add-filtering and modulation operations on an optical signal in a single device. The method includes providing a plurality of ring resonators that are arranged to receive an optical signal of a specific wavelength to be added onto a bus line that is comprised of a plurality of signals at different wavelengths. The method also includes embedding at least one Mach-Zehnder Interferometer (MZI) structure in the plurality of ring resonators. The at least one MZI structure and ring resonators provide modulation and filtering so that the optical signal can be added to the bus line without affecting the channels contained in the bus line.

According to another aspect of the invention, there is provided a system for performing add-filtering and modulation. The system includes a plurality of ring resonators that are arranged to receive an optical signal of a specific wavelength to be added unto a bus line that is comprised of a plurality of signals and channels. At least one Mach-Zehnder Interferometer (MZI) structures is embedded in the plurality of ring resonators. The at least one MZI structure and ring resonators provide modulation and filtering so that the optical signal can be added to the bus line without affecting the channels contained in the bus line.

### BRIEF DESCRIPTION OF THE DRAWINGS

FIG. 1 is a schematic diagram of a device comprising the functionality of both a modulator and an add-filter;

FIG. 2 is schematic diagram of an embodiment of the device of the invention;

FIG. 3 is a schematic diagram of an add-filter/modulator device using a plurality of Mach-Zehnder Interferometers (MZIs) and ring resonators;

FIGS. 4A-4B are graphs of the spectral behavior of the inventive structure defined in FIG. 3;

FIGS. 5A-5B are graphs demonstrating when the central wavelength of the filter is tuned out of the C-band and thus it is equivalent to a switch off for the λᵢ signal;

FIGS. 6A-6B are graphs demonstrating the case where no channel can resonate in the structure;

FIGS. 7A-7B are graphs showing the possibility of tuning the structure; and

FIG. 8 is schematic diagram of a cascaded add-filter arrangement.

### DETAILED DESCRIPTION OF THE INVENTION

The invention provides a single device that behaves at the same time as a signal-switching device and add-filter. Furthermore, the invention is configured to operate on a single channel but the central wavelength can be tuned over a very large bandwidth using standard tuning and switching mechanisms. Finally, the invention can be used as a building block fully integratable on an optical chip for providing more complex functionalities.

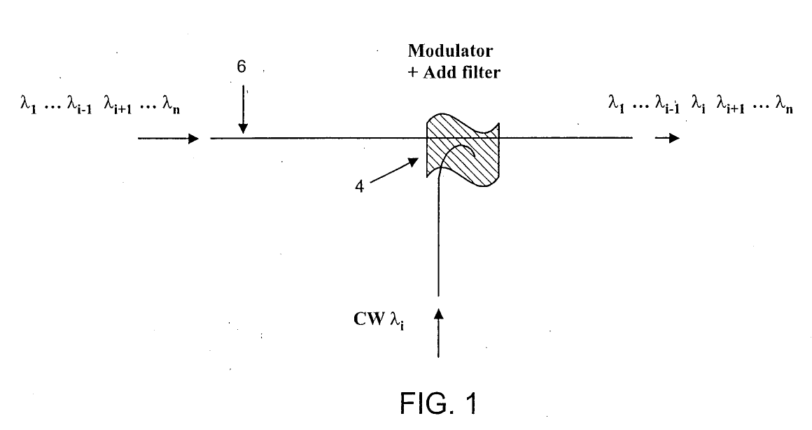

FIG. 1 is a schematic diagram of a device 4 comprising the functionality of both a modulator and an add-filter. The device 4 combines signal modulation and add-filtering using a “nested function ring resonator” structure and standard tuning to modify locally the index of refraction.

The nested function ring resonator introduces interferometric functions along the path of a ring resonator. This operation introduces new degrees of freedom in tailoring the standard resonant response of a ring resonator.

In particular, FIG. 1 shows the device coupled to a CW λᵢ signal that will be inserted onto a bus line 6 having channels defined by wavelengths λ₁ . . . λᵢ₋₁..λᵢ₊₁ . . . λₙ. The device 4 performs the necessary add-filtering and modulation to provide a modulated λᵢ signal to the bus line.

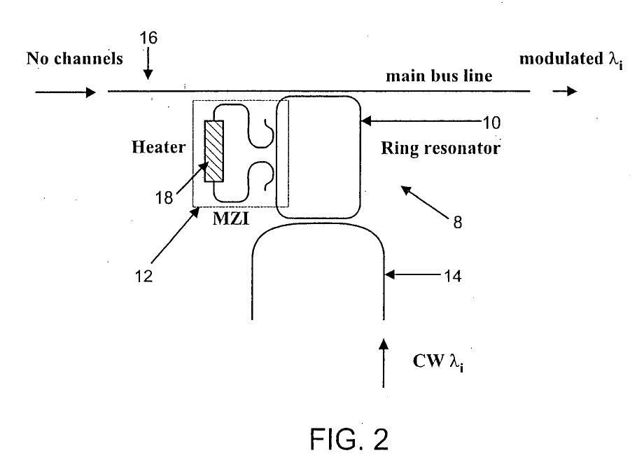

FIG. 2 is schematic diagram of an embodiment of a device 8 in accordance with the invention. The device 8 includes an unbalanced Mach-Zehnder Interferometer (MZI) 12, a ring resonator 10, a main bus line 16, and an input bus line 14. The input bus line 14 receives a CW signal at wavelength λᵢ that will be added to the main bus line 16 that contains no channels as an example. However, the bus line 16 can include a selective number of channels. Furthermore, the MZI 12 comprises a heater structure or other tuning element 18 for tuning the MZI 12, which will be described hereinafter.

An unbalanced interferometer 12, such as unbalanced Mach-Zehnder interferometer (MZI), generates a frequency dependent response. The response of the unbalanced interferometer embedded within the resonating path of the ring resonator can be tailored so as to enhance resonance at one or more selected frequencies and at the same time to hinder resonance at some other of the frequencies that would otherwise resonate in the ring resonator if the unbalanced interferometer was absent.

The unbalance of the MZI structure, i.e., the path length difference Δ1, is such that the MZI structure has a Free Spectral Range, i.e., a frequency spacing between adjacent transmission maxima, lower than the bandwidth of interest. It has been determined that in practice the unbalance Δ1 should be of at least 500 nm. The specific value of unbalance Δ1 is selected as a function of the spectral response of the filter, in particular with a view to adjust the spectral response of the MZI so as to selectively suppress resonance for some of the peaks that would otherwise resonate in the simple ring without MZI. While different values of unbalance may be appropriate from a spectral point of view, a longer unbalance may be advantageous from a technological point of view. Typical preferred values are, e.g, included in the range from 50 to 500 μm.

If the heater structure or tuning element 18 is in its ON state, the MZI 12 lets the signal at λᵢ resonate along the ring 10 and couple to the bus line 16. If the heater or tuning element 18 is on its OFF state, the MZI 12 doesn't let the signal at λᵢ resonate along the ring 10 and then no signal at λᵢ will arrive to the bus line 16. The ring resonator 10 and MZI 12 both aid in modulating and adding the modulated signal at λᵢ to the main bus line 16.

As described herein, the use of an unbalanced interferometer for modulating gives enhanced modulation efficiency. In fact, power transmission through a MZI modulator is given by the formula:
I=I₀ sin²[β(n₂L₂−n₁L₁)]
where I₀ is the peak transmitted power, β=2π/λ is the vacuum propagation constant of the optical signal, n1, n2 are the effective refractive indexes in the two interferometer arms and L₁, L₂, are the lengths of the interferometer arms. Usually, modulation over a broad band requires a very large FSR for the MZI, which in turns means a MZI with balanced arms (L₂=L₁).

In the present solution the modulator is embedded in the add filter. The bandwidth of interest for the add-filter device is typically that of a single channel. A MZIs with unbalanced arms (L₂>>L₁) is used and this means that path differences are amplified by a factor L₂/L₁. This leads to a corresponding increase in the phase shift between the interferometer arms and, accordingly, to a corresponding increase in modulation efficiency.

This very simple configuration can suffer from a number of problems. The spectral response at λᵢ is Lorentizian, which is the typical response of a simple ring resonator. This means that the bandwidth of the filter is very narrow and when the filter or the CW laser are not well tuned, high losses will be present in the modulated signal. More than one ring resonator can be used, so as to make a higher order filter.

In the practical situation, the Free Spectral Range (FSR) of this configuration is very small. One of the goals of the invention is not to affect other channels present in the main bus line. In order to accomplish this task, several nested function ring resonators can be used. Furthermore, if only one nested function ring resonator is used, some channels, different from λᵢ will suffer losses while passing through the device. Thus, there is a practical reason to have more than just one nested function ring resonator.

In this exemplary embodiment, the wavelength range is 1530-1562 nm, which is the C-Band and the channel spacing is 100 GHz. The passband bandwidth at 1 dB is 40 GHz and the throughput isolation is 30 dB.

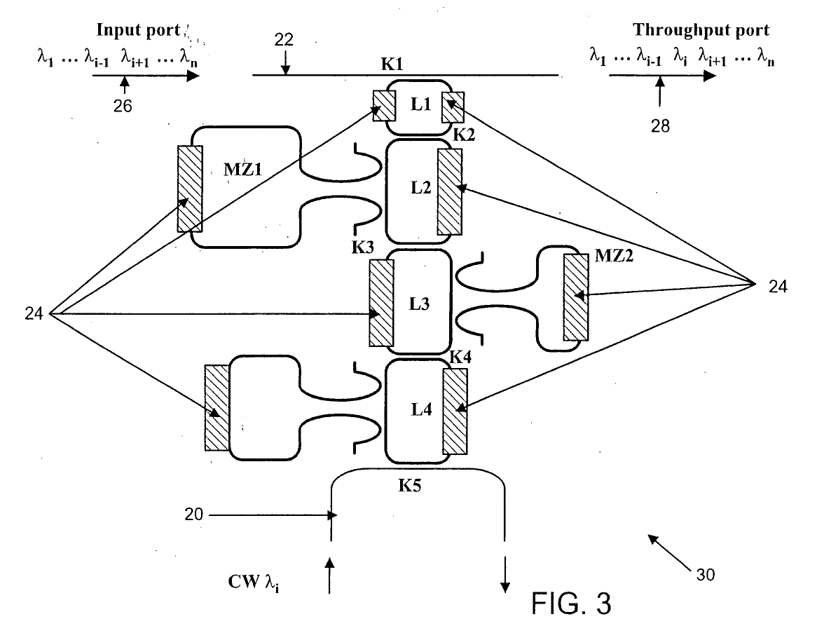

FIG. 3 is a schematic diagram of an add-filter/modulator device 30 using a plurality of MZIs and ring resonators. The device 30 includes an input/output waveguide 20 that receives a CW signal at λᵢ, MZIs 1, 2, 3, and ring resonators L1, L2, L3, and L4. Each of the ring resonators L2, L3, and L4 includes a heater or tuning elements. The ring resonator L1 also includes heating or tuning elements 24. Also, the MZIs 1, 2, 3 include heater or tuning elements 24 as well. A main bus line 22 includes both an input port 26 having channels λ₁ . . . λᵢ₋₁..λᵢ₊₁ . . . λₙ and throughput port 28 having channels λ₁ . . . λᵢ₋₁.λᵢ.λᵢ₊₁ . . . λₙ.

In this embodiment, ring resonator L1 has a ring length of 140 μm and ring resonators L2-L4 have ring lengths of 280 μm. Moreover, the power coupling coefficients K1 is 25%, K2 and K3 are 2.2%, K4 is 4.3%, and K5 is 44%. The extra-length of MZI 1 is 420 μm, MZI 2 is 210 μm, and MZI 3 is 360 μm, where the extra length is the length difference for two arms of an unbalanced MZI structure.

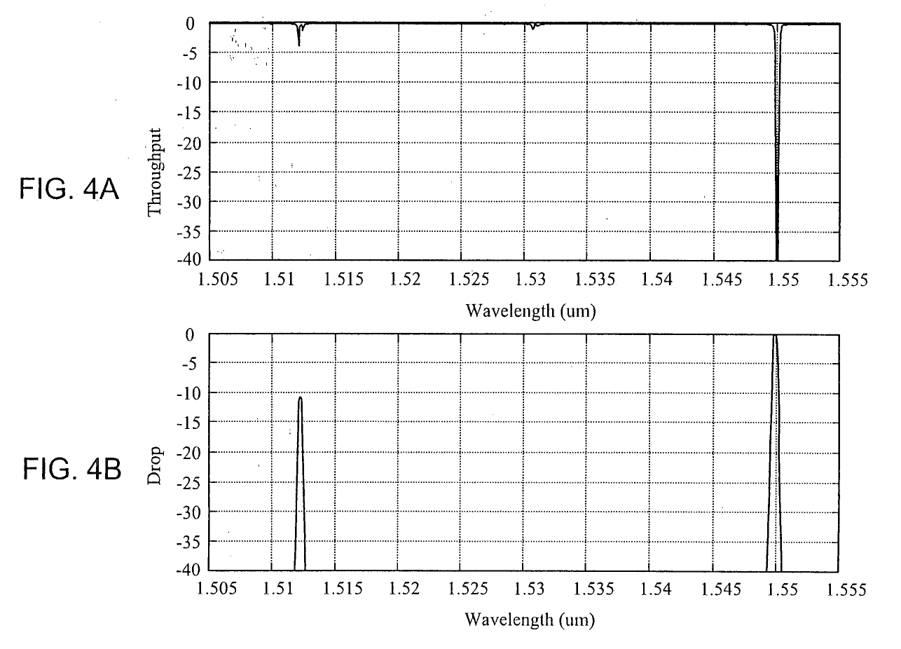

FIGS. 4A-4B are graphs of the spectral behavior of the inventive structure defined in FIG. 3. The band of interest in this embodiment is the C-band (1530-1562 nm). FIG. 4A shows the spectral behavior at the throughput port and FIG. 4B is the spectral behavior at the drop port. Furthermore, the structure used in FIG. 3 is ON.

It is possible to appreciate the extinction of adjacent channels at the drop port (>40 dB).

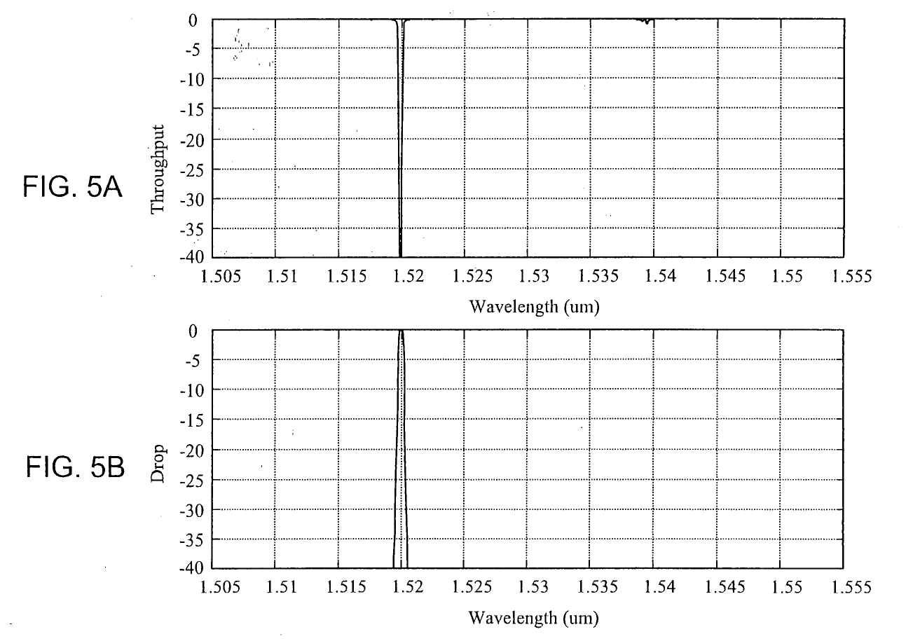

FIGS. 5A-5B are graphs demonstrating when the MZI's response is selected so that the filter is tuned to a wavelength outside the operating band, so that the signal at λᵢ is switched off. FIG. 5A shows the spectral behavior at the throughput port, and FIG. 5B shows the spectral behavior at the drop port.

In addition, FIGS. 5A-5B shows an obtained extinction at λᵢ that is very high (>40 dB) at the drop port. The speed of the switching depends on the mechanism that has been chosen to modify the path lengths of the unbalanced MZIs. It can be, e.g., a thermal mechanism or an electro-optic mechanism. In the case of the thermal mechanism, the switching time is of the order of ms. Furthermore, in the case of the electro-optic mechanism, the switching time would be orders of magnitude shorter.

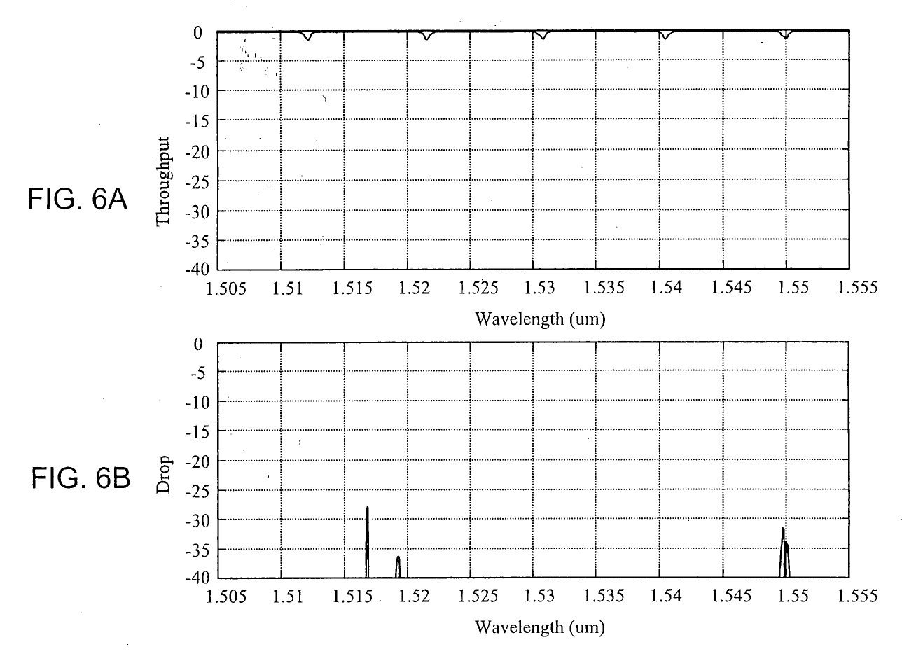

FIGS. 6A-6B are graphs demonstrating the case where the MZI response is tuned so that no channel can resonate in the filter structure. In this case, the channel cannot resonate at λᵢ or at any different wavelengths, inside or outside the operating band. FIG. 6A shows the spectral behavior of the throughput port, and FIG. 6B shows the spectral behavior of the drop port. In this example, some losses are present at the throughput port (<1.5 dB).

In addition, there is a very high extinction for the channel at λᵢ (>30 dB). As to the switching mechanisms, they are similar to those described in FIGS. 5A-5B.

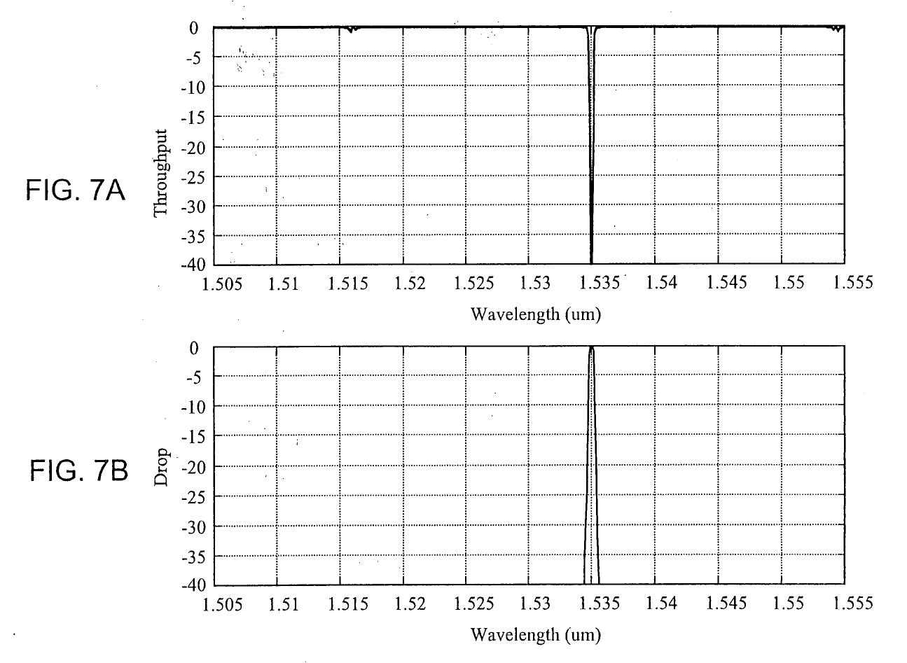

FIGS. 7A-7B are graphs showing the possibility of tuning the structure. In particular, the structure is tuned so that it operates on a different channel that is at a different wavelength within the operating band. In order to choose whatever channel within the ITU grid with 100 GHz channel spacing, it is necessary to apply tuning mechanisms not only to MZIs but also to the rings described in FIG. 3.

FIG. 7A shows the spectral behavior of the throughput port, and FIG. 7B shows the spectral behavior of the drop port. FIGS. 7A and 7B demonstrate that the resonant frequency for the structure is at 1.535 μm. This further demonstrates that the resonant frequency can be tuned at the user's liking without requiring much complexity.

In this way, it is possible to combine the two different operations of signal modulation and add-filtering. The structure modulates a single channel at a time, but it can operate at whatever channel within the operating band. Moreover, a modulated channel will be added to the main bus line without affecting the other channels that are passing in the main bus.

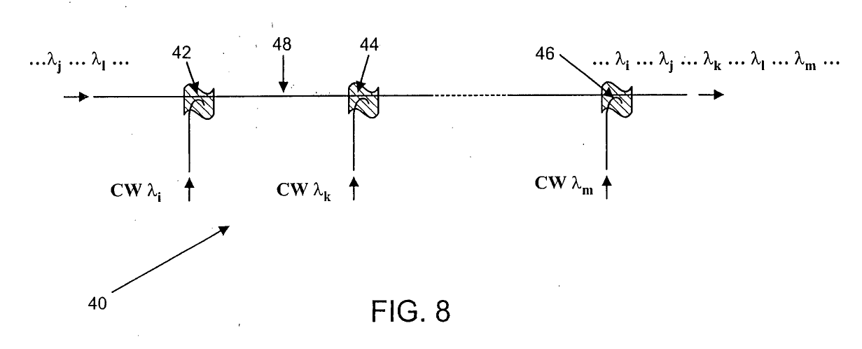

FIG. 8 is schematic diagram of a cascaded add-filter arrangement 40. The cascaded filter arrangement 40 includes three add-filter structures 42, 44, and 46, where each is similar to the structure 30 described in FIG. 3. The main bus line 48 includes channels λ₁ . . . λⱼ. The add-filter structures 42, 44, and 46 input to the main bus line 48 input signals λᵢ.λₖ.λₘ after modulating them. The total effect of the cascaded add-filter arrangement 40 allows inputting onto a bus several modulated input signals without requiring much complexity after modulating them. The cascadibility of several add-filtering arrangements can allow any number of add-filter structures to be used.

Another aspect of the invention is the use of the same structure as a switch mechanism and as add filter arrangement at the same time. The invention provides the use of “nested function resonators” that permit using larger ring resonators for filtering functions. In fact, the FSR of the filter is no more strictly linked with the FSR of the single ring or rings that compose the whole filter. Moreover, it is possible to have long rings with high FSR, for example, 300 μm long rings to obtain 40 nm FSR. The invention also allows low contrast index waveguides to be used and at the same time to have high FSR, because the invention has eliminated the need for very short rings with very tight bends. The bandwidth of the filter is not anymore strictly linked with the FSR. In fact, if the desired FSR is fixed, it is possible to vary the length of the rings and thus the overall bandwidth. Furthermore, all fabrication steps can be relaxed if big dimensions are used.

In addition, the invention can be used for tuning, switching, trimming. Being fully integrated on an optical chip, the invention improves compactness and integratability of the Add tunable filter and the modulator. The same approach can be used for developing a Drop tunable filter. In fact the same building blocks can be used to make the Drop filter.

The invention can be used in both integrated optics devices, such as planar waveguides, or fiber optics.

In the preferred case of use in planar optics, the described structures can be comprised of different materials, such as SiO₂:Ge for the waveguide and SiO₂ for the cladding or SiON for the waveguide and SiO₂ for the cladding or Si₃N₄ for the waveguide and SiO₂ for the cladding. Other material combinations can be used in accordance with the invention.

Furthermore, the invention can be used with optical fibers or Planar Lightwave Circuits (PLCs). The invention can significantly improve the performance of optical signals traveling in these structures.

Although the present invention has been shown and described with respect to several preferred embodiments thereof, various changes, omissions and additions to the form and detail thereof, may be made therein, without departing from the spirit and scope of the invention.

1. An add-filter device comprising:
a plurality of ring resonators that are arranged to receive an optical signal of a specific wavelength; and
at least one Mach-Zehnder Interferometer (MZI) structure that is embedded in said plurality of ring resonators, said at least one MZI structure and ring resonators providing modulation and filtering so that said optical signal can be added to a bus line without affecting the channels contained in said bus line.

2. The add-filter device of claim 1, wherein said ring resonators comprise heater elements.

3. The add-filter device of claim 1, wherein said at least one MZI structure comprises heater elements.

4. The add-filter device of claim 1, wherein said at least one MZI structure comprises unequal arm lengths.

5. The add-filter device of claim 1 further comprising a drop port.

6. The add-filter device of claim 1 further comprising a throughput port.

7. The add-filter device of claim 1, wherein said at least one MZI structure comprises more than one MIZ structure having different materials.

8. The add-filter device of claim 1, wherein said at least one MZI structure comprises more than one MIZ structure having different dimensions.

9. The add-filter device of claim 1, wherein said at least one MZI structure is be controlled via the electro-optic effect.

10. A method of performing add-filtering and modulation operations on an optical signal in a single device, comprising:
providing a plurality of ring resonators that are arranged to receive an optical signal of a specific wavelength to be added onto a bus line that includes a plurality of signals at different wavelength; and
providing at least one Mach-Zehnder Interferometer (MZI) structure that is embedded in said plurality of ring resonators, said at least one MZI structure and ring resonators providing modulation and filtering so that said optical signal can be added to the bus line without affecting the channels contained in said bus line.

11. The method of claim 10, wherein said ring resonators comprise heater elements.

12. The method of claim 10, wherein said at least one MZI structure comprises heater elements.

13. The method of claim 10, wherein said at least one MZI structure comprises unequal arm lengths.

14. The method of claim 10 further comprising a drop port.

15. The method of claim 10 further comprising a throughput port.

16. The method of claim 10, wherein said at least one MZI structure comprises more than one MIZ structure having different materials.

17. The method of claim 10, wherein said at least one MZI structure comprises more than one MIZ structure having different dimensions.

18. The method of claim 10, wherein said at least one MZI structure is controlled via the electro-optic effect.

19. A system for performing add-filtering and modulation comprising:
a plurality of ring resonators that are arranged to receive an optical signal of a specific wavelength to be added onto a bus line that is arranged to receive a plurality of signals at different wavelengths; and
at least one Mach-Zehnder Interferometer (MZI) structure that is embedded in said plurality of ring resonators, said at least one MZI structure and ring resonators providing modulation and filtering so that said optical signal can be added to said bus line without affecting the channels contained in said bus line.

20. The system of claim 19, wherein said ring resonators comprise heater elements.

21. The system of claim 19, wherein said at least one MZI structure comprises heater elements.

22. The system of claim 19, wherein said at least one MZI structure comprises unequal arm lengths.

23. The system of claim 19 further comprising a drop port.

24. The system of claim 19 further comprising a throughput port.

25. The system of claim 19, wherein said at least one MZI structure comprises more than one MIZ structure having different materials.

26. The system of claim 19, wherein said at least one MZI structure comprises more than one MIZ structure having different dimensions.

27. The system of claim 19, wherein said at least one MZI structure is controlled via the electro-optic effect.
